(19) United States
(12) Patent Application Publication
(10) Pub. No.: US 2012/0127117 A1
(43) Pub. Date: May 24, 2012

(54) CAPACITIVE TOUCHSCREEN STRUCTURE

(76) Inventors: Fu-Tien KU, Taoyuan County (TW); Chia-Yen Li, Taoyuan County (TW)

(21) Appl. No.: 12/954,238

(22) Filed: Nov. 24, 2010

(51) Int. Cl. G06F 3/044

(52) U.S. Cl. 345/174

(57) ABSTRACT

A capacitive touchscreen structure comprises in sequence a surface substrate including a top surface having a touch area, and a bottom surface opposite to the top surface; and a transparent conductive layer formed on the bottom surface of the surface substrate and having at least one electrode pattern arranged on the lateral side of the transparent conductive layer. When an external voltage is applied to the electrode pattern, a surface capacitance is generated on the touch area and variation of the surface capacitance is detected to determine a position where a user touches. A terminal impedance exists between the electrode patterns and has a value of 800-2000Ω. As the surface substrate is arranged on the surface of the overall capacitive touchscreen structure of the present invention, the capacitive touchscreen structure of the present invention is more durable and has higher yield.

### FIELD OF THE INVENTION

The present invention relates to a capacitive touchscreen structure, particularly to a durable capacitive touchscreen structure.

### BACKGROUND OF THE INVENTION

Display devices are widely used in various electronic products to function as media between users and information. Among them, LCD (Liquid Crystal Display) is the mainstream display device because of its slimness, low power consumption and low radiation. Common display devices can only present information to users.

Users still need input devices, such as mice or keyboards, to operate electronic products or input instructions into electronic products, such as personal computers or notebooks. Usually, operating input devices is a barrier for beginners to use electronic devices. Thus, touchscreens, which integrate a touch-control module with a display device, have been developed to realize intuitive operation. As touchscreens simultaneously have functions of information presentation and intuitive operation, they can effectively lower the threshold of operation and also promote the efficiency of input operation. Further, the technology of manufacturing touchscreens is growing sophisticatedly, aside from promoting performance and quality of the products, the manufacture cost thereof also can be greatly reduced. Therefore, touchscreens have been widely applied to common consumer electronics, such as mobile communication devices, tablet computers, digital cameras, digital music players, personal digital assistants (PDA), and global positioning systems (GPS).

The current touchscreens can be categorized into the resistive type, the capacitive type, the sonic type, and the optical type. Among them, the resistive type and the capacitive type are more widely used.

The resistive touchscreen is formed of two ITO (Indium Tin Oxide) conductive layers joined vertically. Applying pressure to the touchscreen enables the conduction between the upper and lower electrodes. The controller detects the voltage variation and then works out the touched position to obtain the signal of the input position. For example, a U.S. Pat. No. 4,822,957 has been widely applied to a five-wire resistive touchscreen of Elo Touch Company. The resistive touchscreen is the cheapest and most popular one on the current market. However, mechanically pressing action in operation causes friction between components and shortens the service life of the resistive touchscreen. Besides, the resistive touchscreen is unlikely to perform complicated instructions.

In a common capacitive touchscreen structure, a conductive layer, such as an ITO layer, is formed on a glass substrate, and electrode patterns are formed on the surface thereof, and then a protective film or an insulating layer is coated on the surface. Sometimes, an anti-noise layer can be arranged below the glass substrate to reduce environment interference. In a common capacitive touchscreen, the voltage is supplied from four corners of the screen, and the electrode patterns form an electric field on the surface of the glass substrate. Touching the screen induces current and causes voltage drop in the touched position. According to the ratio of induced current from the touched position to the four corners that is detected by the controller, the controller can work out the touched position. U.S. Pat. No. 4,198,539, No. 4,293,734, No. 4,371,746, and No. 6,781,579, and a U.S. application Ser. No. 11/409,425 respectively disclosed technologies of capacitive touchscreens.

The capacitive touchscreen can be operated more smoothly than the resistive touchscreen. Further, the capacitive touchscreen is exempted from pressing action for instruction input and has a longer service life. However, the electrode patterns, which are arranged around the conductive layer, protrude from the conductive layer, thus a panel has to be used to cover the electrode patterns. However, such a measure impairs the realization of a full-planar capacitive touchscreen. Limited by material and thickness, the protective film or insulating layer sputter-coated on the outmost layer of the conventional capacitive touchscreen is less likely to promote durability. Although the capacitive touchscreen may adopt a thicker protective film, a protective film thicker than 50 μm disables the operation of the capacitive touchscreen.

### SUMMARY OF THE INVENTION

The primary objective of the present invention is to solve the problems that the conventional capacitive touchscreen can neither achieve durability nor realize a full-planar design. To achieve the abovementioned objective, the present invention proposes a capacitive touchscreen structure, which comprises a surface substrate and a transparent conductive layer in sequence. The surface substrate includes a top surface having a touch area and a bottom surface opposite to the top surface. The transparent conductive layer further comprises at least one electrode pattern arranged on the lateral side of the transparent conductive layer. When an external voltage is applied to the electrode pattern, a surface capacitance is generated on the touch area and variation of the surface capacitance is detected to determine a position where a user touches. A terminal impedance exists between the electrode patterns and has a value of 800-2000Ω.

In one aspect, the surface substrate has a thickness equal to or less than 0.55 mm.

In one aspect, the surface substrate has a dielectric constant of 2.5-4, and the surface substrate is made of a material selected from a group consisting of glass, PMMA (Polymethylmethacrylate), PVC (Polyvinylchloride), Nylon, PC (Polycarbonate), PET (Polyethylene terephthalate), PI (Polyimide), COC (Cyclic Olefin Copolymer), and organic glass.

In one aspect, the transparent conductive layer is sputter-coated on the bottom surface of the surface substrate; alternatively, the transparent conductive layer is an independent film coated on the bottom surface of the surface substrate.

In one aspect, an insulating layer is arranged on one surface of the transparent conductive layer, which is opposite to the surface substrate.

In one aspect, the capacitive touchscreen structure further comprises an optical film arranged on the top surface of the surface substrate and/or on one surface of the transparent conductive layer, which is opposite to the surface substrate.

In one aspect, the capacitive touchscreen structure further comprises an explosion-proof film arranged on the top surface of the surface substrate and/or on one surface of the transparent conductive layer, which is opposite to the surface substrate.

In the present invention, the surface substrate is arranged above the transparent conductive layer and the electrode patterns to replace the protective film or insulating layer, which is sputter-coated on the outer layer of the conventional capacitive touchscreen. Therefore, the capacitive touchscreen structure of the present invention has higher durability. In the present invention, the outer layer is the surface substrate and the electrode patterns are covered by the surface substrate, hence the present invention can realize a full-planar design.

### BRIEF DESCRIPTION OF THE DRAWINGS

FIG. 1 is an exploded view schematically showing a capacitive touchscreen structure according to one embodiment of the present invention;

FIG. 2 is an exploded view schematically showing a capacitive touchscreen structure equipped with an auxiliary functional film according to one embodiment of the present invention; and

FIG. 3 is an exploded view schematically showing a capacitive touchscreen structure according to another embodiment of the present invention.

### DETAILED DESCRIPTION OF THE PREFERRED EMBODIMENTS

The technical contents of the present invention are described in detail in cooperation with the drawings below.

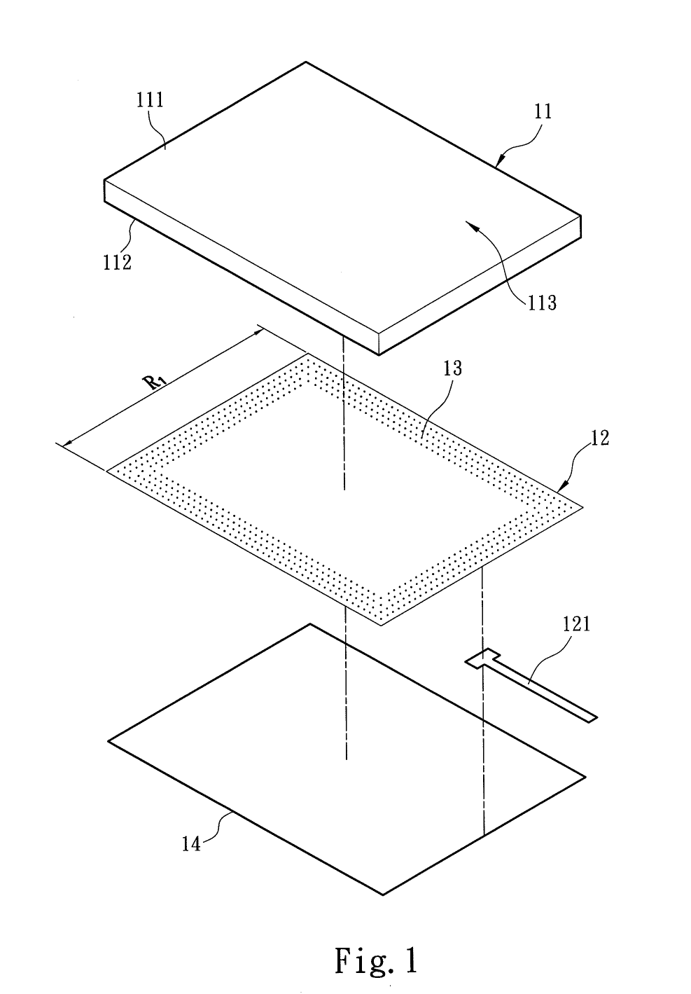

Refer to FIG. 1 an exploded view schematically showing a capacitive touchscreen structure according to one embodiment of the present invention. The capacitive touchscreen structure of the present invention comprises a surface substrate 11 and a transparent conductive layer 12, which are arranged in sequence from top to bottom. The surface substrate 11 includes a top surface 111 having a touch area 113 and a bottom surface 112 opposite to the top surface 111. The surface substrate 11 has a thickness equal to or less than 0.55 mm and has a dielectric constant of 2.5-4. The surface substrate 11 is made of a highly transparent material selected from a group consisting of glass, PMMA (Polymethylmethacrylate), PVC (Polyvinylchloride), Nylon, PC (Polycarbonate), PET (Polyethylene terephthalate), PI (Polyimide), COC (Cyclic Olefin Copolymer), and organic glass. The transparent conductive layer 12 is arranged on the bottom surface 112 of the surface substrate 11. The transparent conductive layer 12 is made of a material selected from a group consisting of ITO (Indium Tin Oxide), ATO (Antimony Tin Oxide), AZO (Aluminum Zinc Oxide) and IZO (Indium Zinc Oxide). The transparent conductive layer 12 further comprises at least one electrode pattern 13 arranged on the lateral side of the transparent conductive layer 12. When an external voltage is applied to the electrode pattern 13, a surface capacitance is generated on the touch area 113 and variation of the surface capacitance is detected to determine a position where a user touches. In order to carry out the transmission of the signal, the transparent conductive layer 12 has a signal transmission member 121 electrically connected with the electrode pattern 13. In this embodiment, the signal transmission member 121 is arranged below the transparent conductive layer 12.

In this embodiment, the transparent conductive layer 12 is sputter-coated on the bottom surface 112 of the surface substrate 11, whereby the transparent conductive layer 12 and the surface substrate 11 are integrated into a single piece of conductive substrate. In this embodiment, the transparent conductive layer 12 is formed in a rectangle shape, and each lateral side thereof has an electrode pattern 13. Two terminals of the electrode pattern 13 have terminal impedance R₁. In the present invention, the terminal impedance R₁ has a value of 800-2000Ω. The transparent conductive layer 12 has an insulating layer 14 on one surface opposite to the surface substrate 11. The insulating layer 14 is made of a non-polar material or a weak-polar material. The non-polar material (μ=0) is selected from a group consisting of polyethylene, polypropylene, polybutadiene, and polytetrafluoroethylene. The weak-polar material (μ≦0.5) may be polystyrene or natural rubber.

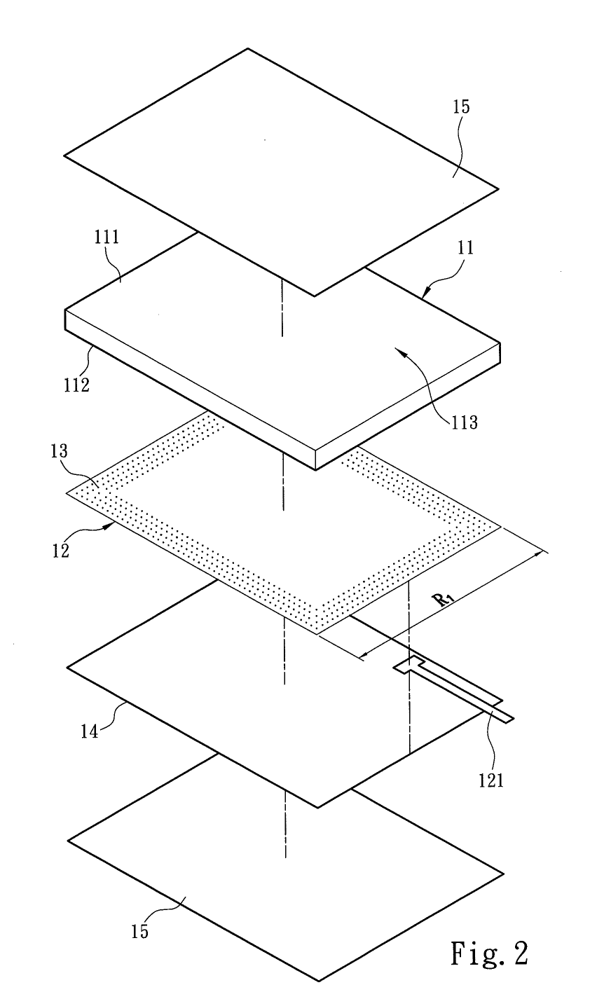

The capacitive touchscreen structure of the present invention may further comprise at least one auxiliary functional film to meet design requirements, such as an optical film or an explosion-proof film. Refer to FIG. 2, wherein two auxiliary functional films 15 are respectively arranged above the top surface 111 of the surface substrate 11 and below the insulating layer 14. However, the present invention does not limit the positions where the auxiliary functional films 15 should be arranged. For example, the auxiliary functional film 15 arranged below the insulating layer 14 can also be arranged on one surface of the transparent conductive layer 12, which is opposite to the surface substrate 11. In one embodiment, a single auxiliary functional film 15 is arranged over the top surface 111 of the surface substrate 11 or on one surface of the transparent conductive 12, which is opposite to the surface substrate 11. The auxiliary functional film 15 can improve the optical or physical performance of the capacitive touchscreen structure of the present invention and promote the value thereof.

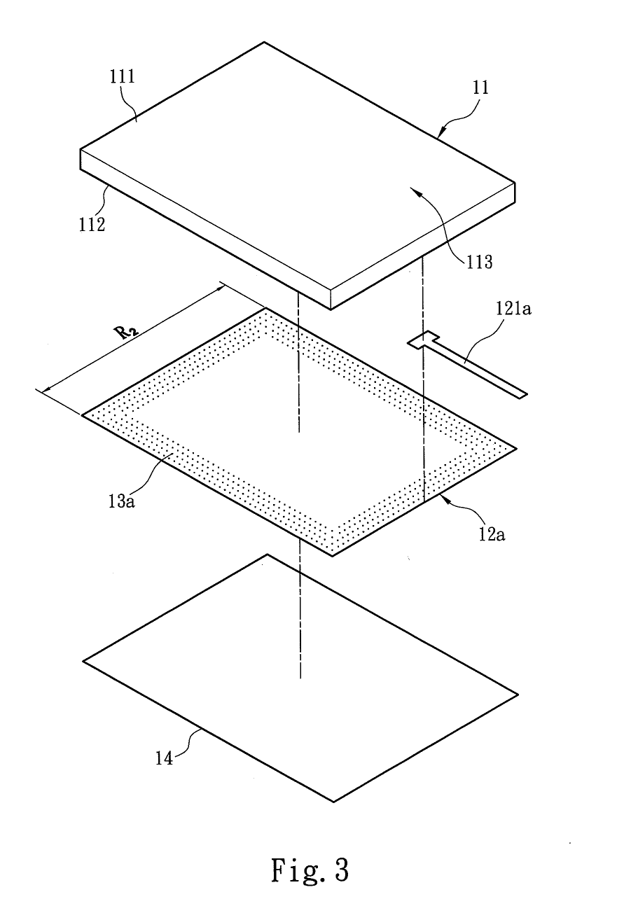

Refer to FIG. 3 an exploded view schematically showing a capacitive touchscreen structure according to another embodiment of the present invention. In the preceding embodiment, the transparent conductive layer 12 is sputter-coated on the bottom surface 112 of the surface substrate 11. In this embodiment, the transparent conductive layer 12a is an independent film coated on the bottom surface 112 of the surface substrate 11. In this embodiment, the transparent conductive layer 12a is formed in a rectangle shape, and electrode patterns 13a are respectively coated or printed on four sides thereof. A terminal impedance R₂ exists between two terminals of the electrode pattern 13a and has a value of 800-2000Ω. As the transparent conductive layer 12a and the electrode patterns 13a are not sputter-coated on the bottom surface 112 of the surface substrate 11, the surface substrate 11 may adopt a non-processed substrate, such as tempered glass. In this embodiment, an insulating layer 14 is also arranged on one surface of the transparent conductive layer 12a, which is opposite to the surface substrate 11. In this embodiment, the transparent conductive layer 12a also has a signal transmission member 121a interposed between the transparent conductive layer 12a and the surface substrate 11. Similarly to the abovementioned embodiment, the capacitive touchscreen structure of this embodiment may further comprise at least one auxiliary functional film, such as an optical film or an explosion-proof film, to improve the optical or physical performance and meet the requirements of design.

In the capacitive touchscreen structure of the present invention, the surface substrate is arranged above the transparent conductive layer and the electrode patterns to replace the protective film or insulating layer sputter-coated on the outer layer in the conventional techniques, so as to improve transparency and durability. Further, the present invention can realize a full-planar design because the electrode patterns are covered by the surface substrate.

The present invention possesses utility, novelty and non-obviousness and meets the condition for a patent. Thus, the Inventors file the application. It is appreciated if the patent is approved fast.

The embodiments described above are only to exemplify the present invention but not to limit the scope of the present invention. Any equivalent modification or variation according to the spirit of the present invention is to be also included within the scope of the present invention.

What is claimed is:

1. A capacitive touchscreen structure, comprising:
a surface substrate including a top surface having a touch area, and a bottom surface opposite to the top surface; and
a transparent conductive layer which is formed on the bottom surface of the surface substrate including at least one electrode pattern arranged on a lateral side of the transparent conductive layer, a surface capacitance being generated and distributed on the touch area while an external voltage being applied to the electrode pattern and variation of the surface capacitance being detected to determine a position where a user touches,
wherein a terminal impedance exists between the electrode patterns and has a value of 800-2000Ω.

2. The capacitive touchscreen structure according to claim 1, wherein the surface substrate has a thickness equal to or less than 0.55 mm.

3. The capacitive touchscreen structure according to claim 1, wherein the surface substrate has a dielectric constant of 2.5-4.

4. The capacitive touchscreen structure according to claim 1, wherein the surface substrate is made of a material selected from a group consisting of glass, PMMA (Polymethylmethacrylate), PVC (Polyvinylchloride), Nylon, PC (Polycarbonate), PET (Polyethylene terephthalate), PI (Polyimide), COC (Cyclic Olefin Copolymer), and organic glass.

5. The capacitive touchscreen structure according to claim 1, wherein the transparent conductive layer includes a signal transmission member electrically connected with the electrode pattern.

6. The capacitive touchscreen structure according to claim 1, wherein the transparent conductive layer includes an insulating layer on one surface opposite to the surface substrate.

7. The capacitive touchscreen structure according to claim 6, wherein the insulating layer is made of a non-polar material selected from a group consisting of polyethylene, polypropylene, polybutadiene, and polytetrafluoroethylene.

8. The capacitive touchscreen structure according to claim 6, wherein the insulating layer is made of a weak-polar material which is polystyrene or natural rubber.

9. The capacitive touchscreen structure according to claim 1 further comprising an optical film.

10. The capacitive touchscreen structure according to claim 9, wherein the optical film is arranged on the top surface of the surface substrate.

11. The capacitive touchscreen structure according to claim 9, wherein the optical film is arranged on one surface of the transparent conductive layer, which is opposite to the surface substrate.

12. The capacitive touchscreen structure according to claim 1 further comprising an explosion-proof film.

13. The capacitive touchscreen structure according to claim 12, wherein the explosion-proof film is arranged on the top surface of the surface substrate.

14. The capacitive touchscreen structure according to claim 12, wherein the explosion-proof film is arranged on one surface of the transparent conductive layer, which is opposite to the surface substrate.

15. The capacitive touchscreen structure according to claim 1, wherein the transparent conductive layer is sputter-coated on the bottom surface of the surface substrate.

16. The capacitive touchscreen structure according to claim 1, wherein the transparent conductive layer is an independent film coated on the bottom surface of the surface substrate.
